(19) United States
(12) Patent Application Publication
(10) Pub. No.: US 2019/0364395 A1
(43) Pub. Date: Nov. 28, 2019

(54) ELECTRONIC DEVICE AND METHOD FOR PROCESSING MESSAGE DATA OF THE ELECTRONIC DEVICE

(71) Applicant: SAMSUNG ELECTRONICS CO., LTD., Suwon-si (KR)

(72) Inventors: Krzysztof TROJANOWSKI, Suwon-si (KR); Pawel BUJNOWSKI, Suwon-si (KR); Justyna RAFALSKA, Suwon-si (KR)

(73) Assignee: SAMSUNG ELECTRONICS CO., LTD., Suwon-si (KR)

(21) Appl. No.: 16/422,043

(22) Filed: May 24, 2019

(30) Foreign Application Priority Data
May 25, 2018 (KR) 10-2018-0059795

(51) Int. Cl. H04W 4/12; G06F 17/27; G06K 9/00

(52) U.S. Cl. CPC H04W 4/12; G06K 9/00624; G06F 17/2785

(57) ABSTRACT

An electronic device and a method for processing message data are provided. The electronic device includes: an input device configured to receive a user input; a communication circuit; and a processor configured to: generate message data including at least one of text or an image based on the user input, select at least one recipient of the message data based on the user input, identify whether the message data is sensitive data for the at least one recipient, and based on the sensitive data being identified as the sensitive data for the at least one recipient, determine a transmission method of the message data.

### CROSS-REFERENCE TO RELATED APPLICATION(S)

This application is based on and claims priority under 35 U.S.C. 119 to Korean Patent Application No. 10-2018-0059795, filed on May 25, 2018, in the Korean Intellectual Property Office, the disclosure of which is herein incorporated by reference in its entirety.

### BACKGROUND

### 1. Field

The disclosure relates to an electronic device and, more particularly, to an electronic device capable of transmitting and/or receiving text and/or image-based messages to and from another electronic device, and a method of processing message data of the electronic device.

### 2. Description of Related Art

The above information is presented as background information only to assist with an understanding of the disclosure. No determination has been made, and no assertion is made, as to whether any of the above might be applicable as prior art with regard to the disclosure.

With the development of mobile communication technology and processor technology, portable terminal devices (hereinafter, referred to as electronic devices) can realize various applications in addition to the conventional communication functions. Among them, text-based message applications are the most widely used technologies in mobile communication-based electronic devices.

The user of the electronic device can create textual data or insert image data through a touch input and/or a key input, and select recipient information from a contact list or directly input the recipient information (e.g., telephone number, email address, or the like), thereby transmitting the created message data to the corresponding recipient. In addition, recent electronic devices can input textual data or input recipient information through speech recognition technology.

### SUMMARY

Provided are an electronic device and a method for processing message data which can process message data in accordance with a user's intention if sensitive data is contained in message data created by the user or message data received from another device.

In accordance with an aspect of the disclosure, there is provided an electronic device comprising: an input device configured to receive a user input; a communication circuit; and a processor configured to: generate message data including at least one of text or an image based on the user input, select at least one recipient of the message data based on the user input, identify whether the message data is sensitive data for the at least one recipient, and based on the sensitive data being identified as the sensitive data for the at least one recipient, determine a transmission method of the message data.

If the message data is the sensitive data for the selected recipient, the processor may stop the transmission of the message data or change the at least of the text or the image included in the message data.

If the message data is the sensitive data for the selected recipient, the processor may change the at least one recipient.

The processor may be configured to identify whether the message data is the sensitive data based on information received from an external device.

The processor may be configured to analyze the text included in the message data through natural language processing to identify whether the message data is the sensitive data.

The processor may be configured to analyze the image included in the message data through object recognition to identify whether the message data is the sensitive data.

The processor may be configured to determine a category to which the at least one recipient belongs based on preset category information, and identify whether the message data is the sensitive data based on the category of the at least one recipient.

The processor may be configured to determine the category to which the at least one recipient belongs based on at least one of predetermined rules, message transmission statistics, or message content analysis.

In accordance with an aspect of the disclosure, there is provided an electronic device comprising: a communication circuit configured to receive message data from an external device; a display; and a processor configured to: analyze at least one of text or an image included in the message data, identify whether the message data is sensitive data based on an analysis result, and determine a display method of the message data through the display based on the identification result.

The processor may be configured to identify whether the message data is the sensitive data based on information received from an external device.

The processor may be configured to, if the message data is the sensitive data, display a Graphic User Interface (GUI) for deciding whether to display the message data.

If the message data is the sensitive data, the processor may determine the display method of the message based on the predetermined settings include at least one of a time, a date, or a place.

In accordance with an aspect of the disclosure, there is provided a message processing method of an electronic device, comprising: generating message data including at least one of text or an image based on a user input; selecting at least one recipient of the message data; identifying whether the message data is sensitive data for the at least one recipient; and based on the sensitive data being identified as the sensitive data for the at least one recipient, determining a transmission method of the message data.

The determining of the transmission method may include at least one of: stopping the transmission of the message data; and changing the at least of the text or the image included in the message data, if the message data is the sensitive data for the selected recipient.

The determining of the transmission method of the message data may include excluding the at least one recipient, if the message data is the sensitive data for the selected recipient.

The identifying of whether the message data is the sensitive data may comprise identifying whether the message data is the sensitive data based on information received from an external device.

The identifying of whether the message data is the sensitive data may include analyzing the text included in the message data through natural language understanding to identify whether the message data is the sensitive data.

The identifying of whether the message data is the sensitive data may include analyzing the image included in the message data through object recognition to identify whether the message data is the sensitive data.

The identifying of whether the message data is the sensitive data may include determining a category to which the at least one recipient belongs based on preset category information, and identifying whether the message data is the sensitive data based on the category of the at least one recipient.

The determining of the category to which the at least one recipient belongs may include determining the category to which the recipient belongs based on at least one of predetermined rules, message transmission statistics, or message content analysis.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment;

FIG. 2 illustrates electronic devices and a message processing server according to an embodiment;

FIG. 3 is a block diagram illustrating a sender electronic device according to an embodiment;

FIG. 4 illustrates modules of a sender electronic device and/or message processing server according to an embodiment;

FIGS. 5 to 8 illustrate a method in which a sender electronic device processes message data according to an embodiment;

FIG. 9 illustrates modules of a sender electronic device and/or message processing server for categorizing a contact list according to an embodiment;

FIG. 10 illustrates modules of an electronic device and/or message processing server for processing generated message data according to an embodiment;

FIG. 11 is a block diagram illustrating a recipient electronic device according to an embodiment;

FIG. 12 illustrates modules of a recipient electronic device and/or message processing server according to an embodiment;

FIG. 13 illustrates a method in which a recipient electronic device processes message data according to an embodiment; and

FIG. 14 is a flowchart illustrating a method of processing message data of a sender electronic device according to an embodiment.

### DETAILED DESCRIPTION

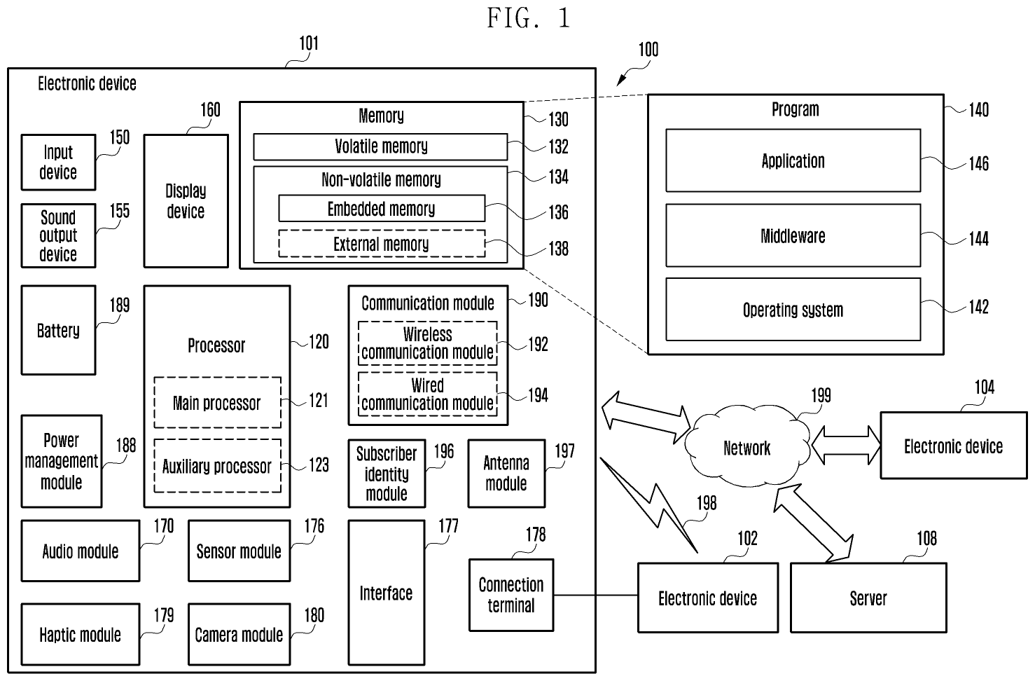

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., short-range wireless communication) in the network environment 100, or may communicate with an electronic device 104 or a server 108 via a second network 199 (e.g., long-range wireless communication). According to an embodiment, the electronic device 101 may communicate with the electronic device 104 via the server 108. According to an embodiment, the electronic device 101 may include a processor 120, a memory 130, an input device 150, an audio output device 155, a display device 160, an audio module 170, a sensor module 176, an interface 177, a haptic module 179, a camera module 180, a power management module 188, a battery 189, a communication module 190, a subscriber identification module 196, and an antenna module 197. In some embodiments, in the electronic device 101, at least one (e.g., the display device 160 or the camera module 180) of these components may be omitted or one or more components may be added. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by the component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or an external electronic device (e.g., an electronic device 102) (e.g., a speaker or a headphone) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture still images and moving images. According to an embodiment, the camera module 180 may include one or more lenses, image sensors, ISPs, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth, Wi-Fi direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The antenna module 197 may transmit or receive a signal or power to or from the outside (e.g., the external electronic device). According to an embodiment, the antenna module 197 may include one or more antennas, and, therefrom, at least one antenna appropriate for a communication scheme used in the communication network, such as the first network 198 or the second network 199, may be selected, for example, by the communication module 190. The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 connected to the second network 199. Each of the electronic devices 102 and 104 may be a device of a same type as or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome by processing the outcome as is or additionally processing the outcome, as at least part of a reply to the request. To that end, a cloud computing, distributed computing, or client-server computing technology may be used, for example.

The electronic device according to an embodiment may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with,”, it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the invoked at least one instruction. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. According to an embodiment, one or more components of the above-described components or operations may be omitted, or one or more other components or operations may be added. Alternatively or additionally, a plurality of components (e.g., modules or programs) may be integrated into a single component. In such a case, according to an embodiment, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

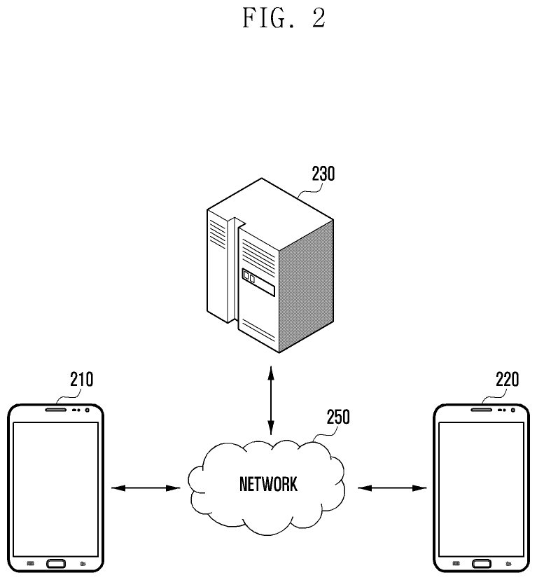

FIG. 2 illustrates electronic devices (i.e., a first electronic device and a second electronic device) and a message processing server according to an embodiment.

Hereinafter, an electronic device that generates and transmits message data is defined as a first electronic device 210 (or a sender electronic device), and an electronic device that receives and displays the message data from the first electronic device 210 is defined as a second electronic device 220 (or a recipient electronic device). That is, the same electronic device may be referred to as the first electronic device 210 or the second electronic device 220, depending on a situation where the message data is transmitted or received. The first electronic device 210 and/or the second electronic device 220 may include at least some of the configuration and/or function of the electronic device 101 of FIG. 1.

The first electronic device 210 may generate message data on the basis of a user input. The message data may include text and images, and may also include instant messages using Short Message Service (SMS), Multimedia Message Service (MMS), e-mail, or other applications. I addition, the first electronic device 210 may select at least one recipient to which the generated message is to be transmitted, on the basis of a user input. Recipient information may be input as phone number, ID, e-mail account, or the like, and can be selected by a user from a contact list stored in the first electronic device 210 or can be input directly by a user (e.g., phone number can be directly input by a user).

The message data transmitted by the first electronic device 210 may be transmitted to the second electronic device 220 via a network 250 (e.g., the network 199 of FIG. 1).

According to an embodiment, the first electronic device 210 may identify whether the input message data is sensitive data for the selected recipient. The sensitive data may refer to textual and/or image data that contains information related to security and/or privacy as information whose content is inappropriate to reveal to selected recipients. For example, in terms of privacy in the case of information requiring security such as a credit card number or expressions mainly used for some close persons such as nicknames, it is inappropriate in terms of the user in that the corresponding sensitive information is transmitted to unintended recipients. According to an embodiment, text and/or images included in message data may be analyzed to identify whether created or received message data contains sensitive data.

According to an embodiment, a process of analyzing whether the created message data contains the sensitive data may be performed by the first electronic device 210 and/or the message processing server 230. For example, when the creation of the message data and the selection of the recipient are completed, the first electronic device 210 may transmit the message data to the message processing server 230, and the message processing server 230 may identify whether the message data is sensitive data for the recipient on the basis of the received data.

According to another embodiment, the processor of the first electronic device 210 may directly identify whether the created message is sensitive data for the corresponding recipient.

The message processing server 230 may analyze message data created by the first electronic device 210 (i.e., message data prior to transmission) or message data received at the second electronic device 220, identify whether the message data is sensitive data, and provide the analysis results to the first electronic device 210 and/or the second electronic device 220. To this end, the message processing server 230 may categorize a contact list of the first electronic device 210 and/or the second electronic device 220, collect log information associated with the transmitted and/or received message, and identify whether sensitive data is contained in message data through natural language processing and/or image analysis. The message processing server 230 may transmit and/or receive the analyzed message data to and/or from the first electronic device 210 and/or the second electronic device 220, or may periodically transmit the same. At least some of operations of the message processing server 230 may be performed by the processor (e.g., the processor 120 of FIG. 1) of the first electronic device 210 and/or the second electronic device 220.

An embodiment such as a process of analyzing the message data (sensitive data) described herein, a process of categorizing the contact list, and a process of providing an alarm to a user may be performed by the first electronic device 210, the second electronic device 220, and/or the message processing server 230. Although described as being performed by a single device, at least some of operations according to an embodiment may be performed in other devices.

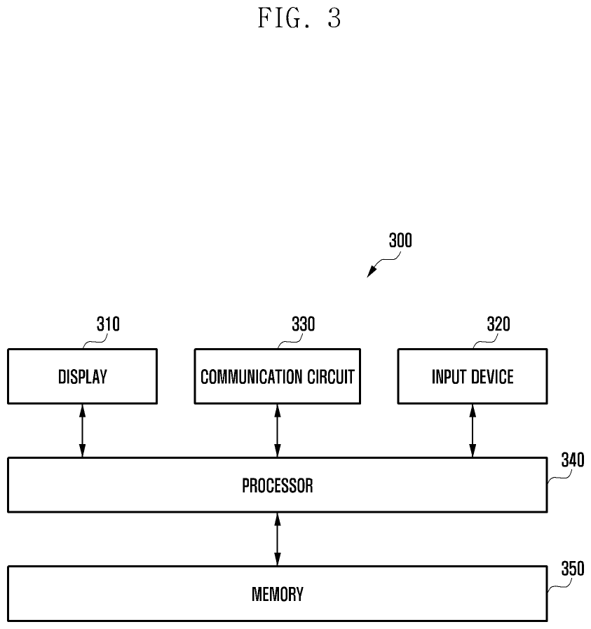

FIG. 3 is a block diagram illustrating a sender electronic device according to an embodiment.

As described above, the same electronic device can be operated as a sender electronic device (or a first electronic device) (e.g., the first electronic device 210 of FIG. 2) or a recipient electronic device (or a second electronic device) (e.g., the second electronic device 220 of FIG. 2) depending on a situation where message data is transmitted or received. Hereinafter, the sender electronic device and the recipient electronic device may be referred to as an electronic device 300 when the configurations of them are described.

As illustrated in FIG. 3, the electronic device 300 according to an embodiment may include a display 310, an input device 320, a communication circuit 330, a processor 340, and a memory 350. An embodiment may be implemented even if at least some of the illustrated configurations are omitted or substituted. The electronic device 300 may be implemented as a smart phone, a tablet PC, a laptop PC, or the like, but is not limited thereto.

According to an embodiment, the display 310 (e.g., the display device 160 of FIG. 1) may display a video, and may be implemented as any one of a liquid crystal display (LCD), a light-emitting diode (LED) display, an organic light-emitting diode (OLED) display, a micro electro mechanical systems (MEMS) display, and an electronic paper display, but is not limited thereto.

According to an embodiment, the input device 320 may sense a user input and may provide the sensed input signal to the processor 340. The input device 320 may be implemented as a touch screen capable of sensing a user's touch input, may be embedded in the display 310 as an on-cell type, an in-cell type, or the like, and may be attached to the display 310 in various forms such as a glass scheme, a film scheme, and the like. According to an embodiment, the input device 320 may include a voice input device 320 (e.g., a microphone), which may receive a user's voice and convert the received user's voice into textual information for use in creating message data.

According to an embodiment, the communication circuit 330 (e.g., the wireless communication module 192 of FIG. 1) is a configuration for wireless communication with other external devices (e.g., the second electronic device 220 and/or the message processing server 230 of FIG. 2). The communication circuit 330 may include at least one antenna and a communication processor (CP), and may transmit/receive data to/from other devices via a network (e.g., the network 250 of FIG. 2).

According to an embodiment, the memory (e.g., the memory 130 of FIG. 1) may include known volatile memory and non-volatile memory, and is not limited to a specific implementation example. The memory 350 may store at least some of the programs 140 of FIG. 1.

The memory 350 may store various instructions that can be executed in the processor 340. Such instructions may include control commands such as arithmetic and logic operations, data movement, input/output, etc., which can be recognized by the processor 340.

According to an embodiment, the processor 340 (e.g., the processor 120 of FIG. 1) is a configuration that is capable of performing operations and data processing related to control and/or communication of each component of the electronic device 300. The processor 340 may be operatively and/or electrically connected to the internal components of the electronic device 300, such as the display 310, the communication circuit 330, the input device 320, the memory 350, etc. The functions performed by the processor 340 are not limited, but, in the disclosure, various operations for receiving a user input through the input device 320, creating message data on the basis of the user input, selecting a recipient, and identifying whether the message data is sensitive data will be described.

According to an embodiment, the processor 340 may generate message data on the basis of a user input through the input device 320. The message data may be generated by various applications (e.g., short message service (SMS)), multimedia message service (MMS), e-mail, chatting application, etc.), and may include at least one of text and an image.

According to an embodiment, the processor 340 may select at least one recipient to which the message data is to be transmitted on the basis of the user input. Recipient information may be input as phone number, e-mail account, or the like, and may be selected by the user from a contact list stored in the electronic device 300 or may be input directly by the user (e.g., a phone number is directly input by the user). The user may select a plurality of recipients for the same message data. The recipients may be determined in advance by the user input, and/or the user may select a group including a plurality of recipients categorized according to the analysis of the processor 340 or an external device (e.g., the message processing server 230 of FIG. 2), as the recipients.

According to an embodiment, the processor 340 may identify whether the message data is sensitive data for the selected recipient. The sensitive data may refer to textual and/or image data that contains information related to security and/or privacy as information whose content is inappropriate to reveal to selected recipients. For example, in the case of information requiring security such as a credit card number or expressions mainly used for some close persons such as nicknames, it is inappropriate in terms of the user in that the corresponding sensitive information is transmitted to unintended recipients in terms of privacy. The processor 340 may analyze text and/or image included in the message data and may identify whether the created or received message data contains sensitive data.

According to an embodiment, the processor 340 may analyze text contained in the message data through natural language understanding to identify whether the message data is the sensitive data. For example, the processor 340 may analyze key phrase, semantic and syntactic features, characteristic of language, third person references to receiver, considered topics, personal information, and the like of the input text.

According to an embodiment, the processor 340 may analyze the image contained in the message data through object recognition to identify whether the message data is the sensitive data. For example, the processor 340 may analyze whether the images contain erotic scenes, brutal scenes, private scenes, family photos, etc., through various image analysis methods.

According to an embodiment, the message data may be determined as the sensitive data only for a specific recipient. For example, if nickname such as “honey” is used in the message data, it is a common term for husbands/wives, but it is inappropriate to use the corresponding nickname for colleagues/clients. In this case, the processor 340 may determine the corresponding message data as the sensitive data when a person who is not suitable for the use of the message data is configured as the recipient.

According to an embodiment, if the message data is the sensitive data for the selected recipient, the processor 340 may determine a method associated with the transmission of the message data. Here, in the method associated with the transmission of the message data, it is possible to stop (or not transmit) the transmission of the message data, change at least a portion of the text and/or image contained in the message data, or exclude the selected recipient. To this end, if the corresponding message data is determined as the sensitive data, the processor 340 may provide a menu used for selecting the method associated with the transmission of the message data to the user, and may operate in response to the user's selection to the menu.

According to an embodiment, a method of analyzing the sensitive data may be performed by an external device (e.g., the message processing server 230 of FIG. 2). In this case, the processor 340 may provide the message data to the external device through the communication circuit 330, and the external device may analyze the message data and the selected recipient and may return information about whether the message data is the sensitive data for the electronic device 300.

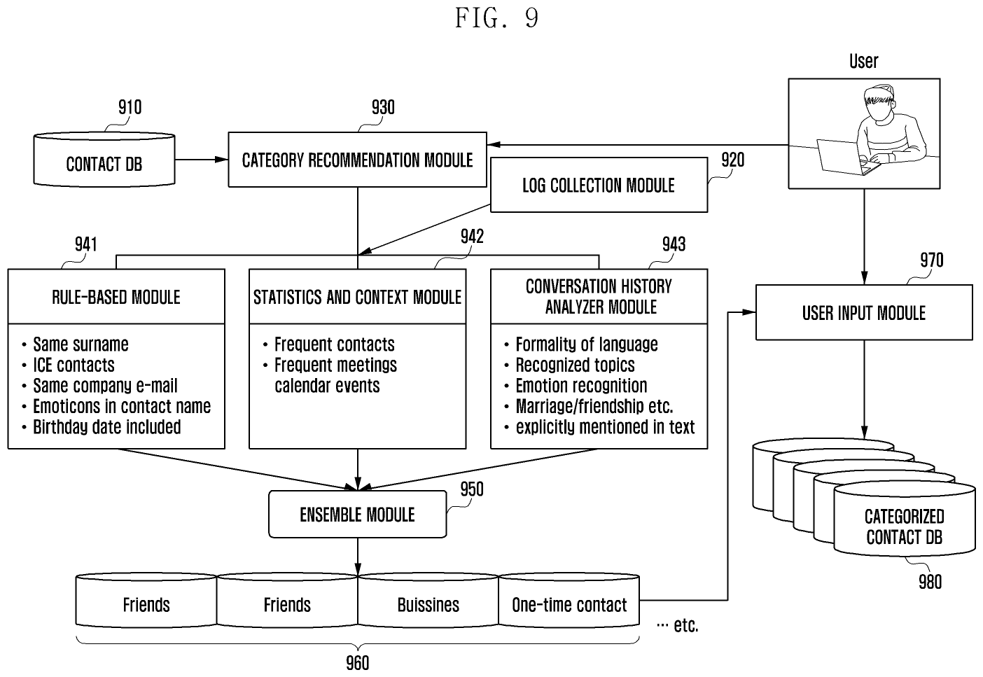

According to an embodiment, the processor 340 may determine a category to which the selected recipient belongs and may identify whether the message data is sensitive data for the category to which the recipient belongs. For example, each contact in the contact list can be classified into family, friends, business relationships, financial relationships, temporary relationships, and the like. The categorizing of such contacts can be based on user input (i.e., based on preset category information) or can be automatically generated by various algorithms. A method of automatically categorizing the contacts may include a method of determining the category to which the recipient belongs on the basis of at least one of predetermined rules, message transmission statistics, and message content analysis, which may be performed by the processor 340 or the external device (e.g., the message processing server 230 of FIG. 2). More details related to the embodiment will be described with reference to FIG. 9.

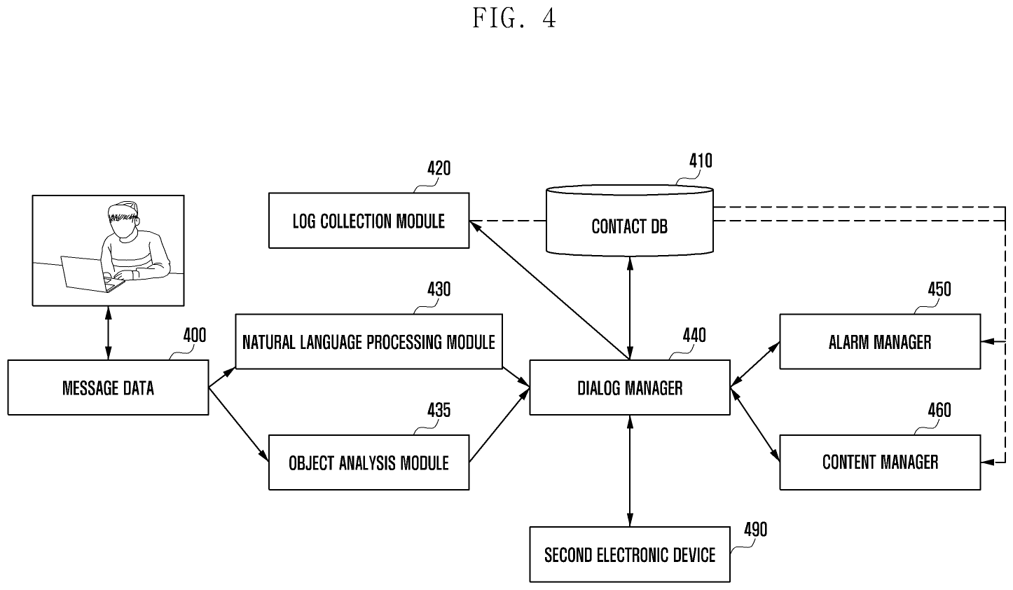

FIG. 4 illustrates modules of a sender electronic device and/or message processing server according to an embodiment.

FIG. 4 illustrates functional blocks for processing message data generated by a user of a sender electronic device (e.g., the electronic device 300 of FIG. 3). One or more of the blocks 410, 420, 430, 435, 44, 450, and 460 may be implemented by hardware and/or software, and may be operated by an external device (e.g., the message processing server 230 of FIG. 2) after message data 400 is generated.

The user may generate the message data 400 using an input device (e.g., a touch screen and/or a voice input device) (e.g., the input device 320 of FIG. 3), and may select at least one recipient. The message data 400 may contain text and/or image.

A natural language processing module 430 may analyze text contained in the message data through natural language understanding. For example, the natural language processing module 430 may analyze key phrase, semantic and syntactic features, characteristic of language, third person references to receiver, considered topics, personal information, and the like of the input text.

An object analysis module 435 may analyze an image included in the message data through object recognition.

A contact database (DB) 410 may include information about at least one contact stored by the user, and may categorize and store each contact as family, friends, business relationships, financial relationships, temporary relationships, and the like on the basis of the selection of the user or the analysis of the processor (e.g., the processor 340 or the message processing server of FIG. 3).

The processing results of the natural language processing module 430 and the object analysis module 435 may be provided to a dialog manager 440. The dialog manager 440 (or a conversation manager) may identify whether the text and/or image contained in the created message data is sensitive data for the selected recipient with reference to the processing results of the natural language processing module 430 and the object analysis module 435 and the contact DB 410.

If the text and/or image contained in the created message data is the sensitive data on the basis of the identification result of the dialog manager 440, the corresponding information may be provided to an alarm manager 450 and/or a content manager 460.

The alarm manager 450 may generate information for notifying a user of the fact that the sensitive data is contained in the message data, and may output the generated information through a display (e.g., the display 310 of FIG. 3). For example, the alarm manager 450 may output information indicating that the created message data is the sensitive data through a pop-up window, and may provide a menu that allows the user to select a possible processing method (e.g., transmission interruption, message data modification, change of recipient, transmission as is, etc.) to the user.

The content manager 460 may change at least a portion of the message data and/or the selected recipient in accordance with the selection of the user according to the menu provided by the alarm manager 450.

The processing results of the alarm manager 450 and the content manager 460 may be returned to the dialog manager 440, and the dialog manger 440 may determine a transmission method of the message data on the basis of the processing results. The transmission method may be determined by the selection of the user through the menu.

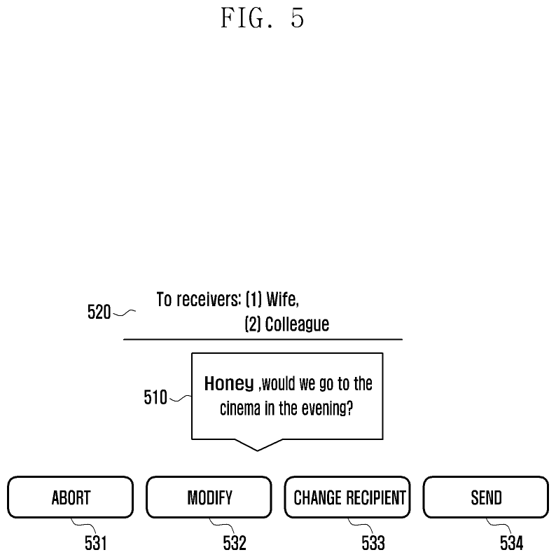

FIGS. 5 to 8 illustrate a method in which a sender electronic device processes message data according to an embodiment.

Referring to FIG. 5, a user may input message data 510 including text “Honey, would you go to the cinema in the evening?” using an input device (e.g., a touch screen and/or a voice input device) (e.g., the input device 320 of FIG. 3). In addition, the user may select a wife and colleague (one or more or all among contacts belonging to a colleague category) from the contact list, as recipient 520.

A processor (e.g., the processor 340 of FIG. 3) or the message processing server 230 of FIG. 2 may determine that “honey” of the created message data 510 is sensitive data through natural language processing (or using the natural language processing module 430 of FIG. 4). At this time, the processor may determine that “honey” is sensitive data only for the colleague among the selected contacts.

The processor may provide a menu 530 for allowing a user to select a transmission method of the sensitive data to the user according to the determination of the sensitive data. The menu 530 may include an selectable object (e.g., button) 531 for aborting (i.e., interrupting) the message transmission, an selectable object 532 for modifying the message data, an selectable object for changing the recipient 533, and an selectable object 534 for transmitting the message data as is, as shown in FIG. 5.

The processor may transmit the message data or interrupt the transmission according to the selected method on the basis of the selection of the user through the menu 530.

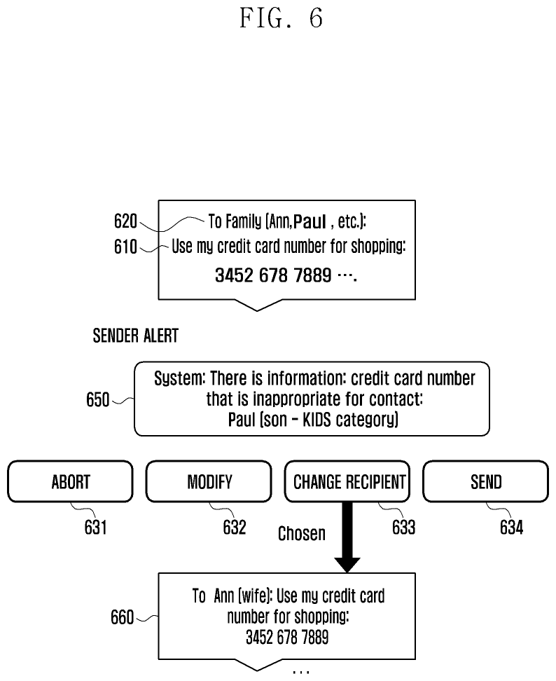

Referring to FIG. 6, the user may input text such as “Use my credit card number for shopping: 3452 678 7889” as message data 610 using the input device, and may select contacts Ann and Paul as recipient 620. Ann and Paul in a contact list may be input directly by the user, and automatically classified into wife and son by previous message transmission history analysis or the like.

The processor may identify that the credit card number in the input message data 610 is sensitive data, and may determine that the credit card number is sensitive data for Paul in consideration of the category of the selected recipient 620.

The processor may display alarm 650 for notifying a user of detection of the sensitive data, in a pop-up manner or the like, and at the same time as displaying the alarm 650 or sequentially thereafter, may provide menu 630 for allowing the user to select the transmission method (or processing method) of the sensitive data.

If the user selects the “change the recipient” button 633 from the presented menu 630, the processor may select only Ann and transmit the message data to Ann while excluding Paul among the recipients selected by the user, as shown in 660.

According to an embodiment, the input device (e.g., the input device 320 of FIG. 3) may include a voice input device (e.g., a microphone), and the user may input the message data and select the recipient using the voice input device.

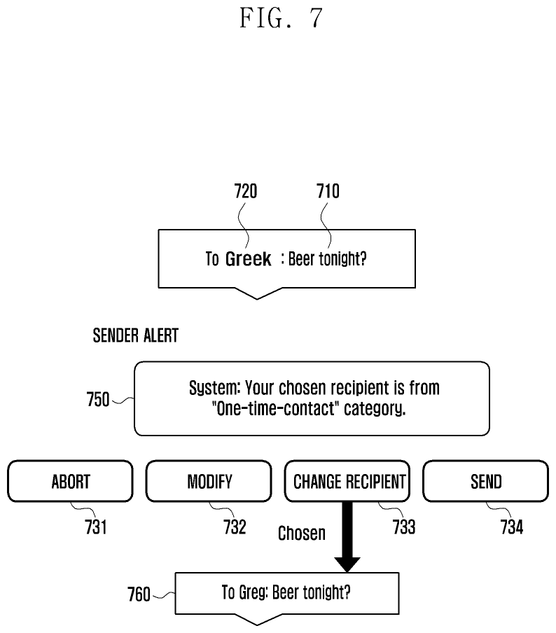

Referring to FIG. 7, the user may input voice to select Greg from the contact list, but the voice input device (or the processor) may determine the input voice as Greek and select Greek as recipient 720. In addition, the user may input “Beer tonight?” as message data 710 using the voice input device or a touch screen.

The processor may identify that the selected contact Greek is categorized into a temporary relationship (e.g., landlady), and thus determine that the input message data is sensitive data for Greek.

In this case, the processor may provide alarm 750 for notifying that the input message data contains sensitive data for the selected recipient Greek according to voice recognition through a display (e.g., the display 310 of FIG. 3).

In addition, the processor may provide the menu including buttons 731, 732, 733 and 734 for allowing a user to select the transmission method (or processing method) of the sensitive data. For example, if the user selects the button 733 for changing the recipient, the processor may search the contact list to find another contact which sounds similar to the input voice data recognized as “Greek.” If Greg is found, the processor may correct Greek to Greg as the recipient. The processor may search for the alternative contact to replace Greek within a category (e.g., friends or family) suitable for the message data among contacts.

According to an embodiment, if the message data contains sensitive data, the processor may change the sensitive data to information (e.g., web link) capable of identifying sensitive data.

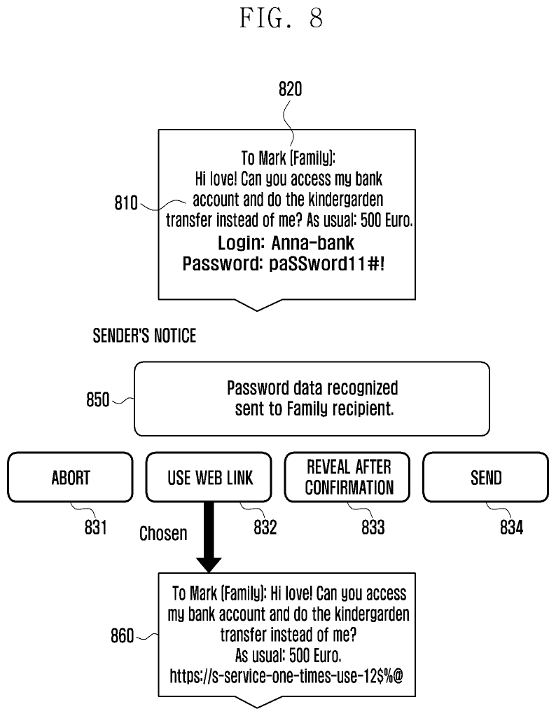

Referring to FIG. 8, the user may input “Hi love! Can you access my bank account and do the kinder garden transfer instead of me? As usual: 500 Euro. Login: Anna-bank Password: paSSword11#!” as message data 810, and may select Mark belonging to family category as recipient 820.

The processor may identify “Login: Anna-bank Password: paSSword11#!” as sensitive data requiring security in the message data 810, and may provide alarm 850 for notifying that the corresponding data is sensitive data.

In addition, the processor may provide menu 830 including buttons 831, 832, 833 and 834 for allowing a user to select a message transmission method. If the user selects use web link button 832, the processor may provide information of the corresponding sensitive data to an external device (e.g., the message processing server 230), and may change the sensitive data to a web link to the external device.

The processor may provide the message data in which the sensitive data is changed to a web link as shown in 860 to the recipient electronic device, and the user of the recipient electronic device may access the web link included in the received message data to identify information of the corresponding sensitive data.

FIG. 9 illustrates modules of a sender electronic device and/or message processing server for categorizing a contact list according to an embodiment.

FIG. 9 illustrates hardware/software blocks for categorizing a plurality of contacts stored in a contact DB 910 (or a contact list) of a sender electronic device (e.g., the electronic device 300 of FIG. 3), and at least some of the illustrated blocks may be performed by an external electronic device (e.g., the message processing server 230 of FIG. 2).

According to an embodiment, an electronic device (e.g., the processor 340 of FIG. 3) and/or the message processing server 230 may classify the plurality of contacts included in the contact DB 910 into categories such as family, friends, business relationships, financial relationships, temporary relationships, and the like. The user may directly determine the category to which the corresponding contact belongs. Alternatively, the category of each contact may be automatically determined through various algorithms.

A category recommendation module 930 may categorize the plurality of contacts included in the contact DB 910 into categories such as family, friends, business relationships, financial relationships, temporary relationships, and the like. The category recommendation module 930 may include a rule-based module 941, a statistics and context module 942, a conversation history analyzer module 943, and an ensemble module 950.

The rule-based module 941 may configure various rules for classifying contacts.

For example, the rule-based module 941 may classify contacts having the same surname into a family category, in case of emergency (ICE) contact number into a separate category, and contacts associated with the same company e-mail domain into a colleague category. In addition, if the contact name includes an emoticon or birthday information, it may be determined that the corresponding contact is a somewhat close relationship, and it can be referred to when determining the category.

The statistics and context module 942 may categorize contacts on the basis of the message transmission and reception records of the electronic device. The message transmission and reception records of the electronic device may be stored by a log collection module 920, and information collected by the log collection module 920 may be provided to the statistics and context module 942.

The statistics and context module 942 may identify the intimacy with each contact by analyzing the number of messages, the number of calls, the number of pictures or documents included in the message data, and the length of the message. In addition, the statistics and context module 942 may analyze information recorded in the message application and other applications (e.g., calendars, schedules, etc.).

The conversation history analyzer module 943 may analyze the content of messages transmitted and/or received to and from each contact. The message transmission and/or reception records of the electronic device may be stored by the log collection module 920, and the information collected by the log collection module 920 may be provided to the conversation history analyzer module 943. The conversation history analyzer module 943 may analyze language formality of the message data, recognized subject, estimated emotion from the message, marital relationship, intimacy, and the like.

The ensemble module 950 may receive analyzed information from the rule-based module 941, the statistics and context module 942, and/or the conversation history analyzer module 943, and may determine the category to which each contact belongs from the received information. As shown in FIG. 9, examples of the categories 960 may include family, friends, business relationship, and temporal relationship (one-time contact), but are not limited thereto.

A user input module 970 may configure and/or change the category to which each contact belongs on the basis of a user input. The user input module 970 may change the category of each contact determined by the category recommendation module 930 (or the ensemble module 950) on the basis of the user input.

The category of each contact determined by the user input module 970 or the category recommendation module 930 may be recorded in the categorized contact DB 980 (or categorized contact DB).

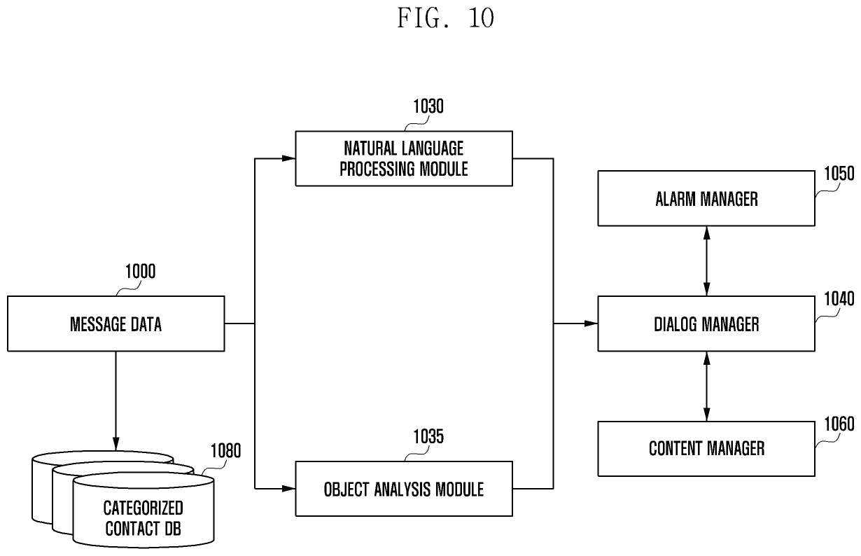

FIG. 10 illustrates modules of an electronic device and/or message processing server for processing generated message data according to an embodiment.

FIG. 10 illustrates functional blocks for processing message data generated by a user of a sender electronic device (e.g., the electronic device 300 of FIG. 3). One or more of the blocks may be implemented by hardware or software. Also, at least some of the blocks may be run by an external device (e.g., the message processing server 230 of FIG. 2) after message data 1000 is generated.

A user may generate the message data 1000 using an input device (e.g., a touch screen and/or a voice input device) (e.g., the input device 320 of FIG. 3), and select at least one recipient. The message data may include text and/or image.

The electronic device may identify the category of the recipient selected from a categorized contact DB 1080. In addition, the electronic device may determine a contact or a category that matches the message data on the basis of the analysis results of a natural language processing module 1030 and an object analysis module 1035 before the user selects a recipient, and may provide determined contact or category to the user.

The natural language processing module 1030 may analyze text included in the message data through natural language understanding. For example, the natural language processing module may analyze key phrase, semantic and syntactic features, characteristic of language, third person references to receiver, considered topics, personal information, and the like of the input text.

An object analysis module 1035 may analyze an image included in the message data through object recognition.

The processing results of the natural language processing module 1030 and the object analysis module 1035 may be provided to a dialog manager 1040. The dialog manager 1040 may identify whether the text and/or image included in the created message data is sensitive data for the selected recipient with reference to the processing results of the natural language processing module 1030 and the object analysis module 1035 and the contact DB 1080.

If the text and/or image is determined to be the sensitive data on the basis of the identification result of the dialog manager 1040, this information may be provided to an alarm manager 1050 and/or a content manager 1060.

The alarm manager 1050 may generate information for notifying the user of the fact that the sensitive data for the selected recipient is included, and may output the generated information through a display. For example, the alarm manager 1050 may output information indicating that the created message data is sensitive data through a pop-up window, and may provide a menu for allowing the user to select a possible processing method (e.g., abort sending, modify the content, change the recipient, send anyway, etc.) to the user.

The content manager 1060 may change at least a portion of the message data and/or the selected recipient according to the selection result of the user according to a menu (e.g., the menu 530 of FIG. 5) provided by the alarm manager 1050.

The processing results of the alarm manager 1050 and the content manager 1060 may be returned to the dialog manager 1040, and the dialog manager 1040 may determine the transmission method of the message data on the basis of the returned information. The transmission method may be selected by the selection of the user through the menu.

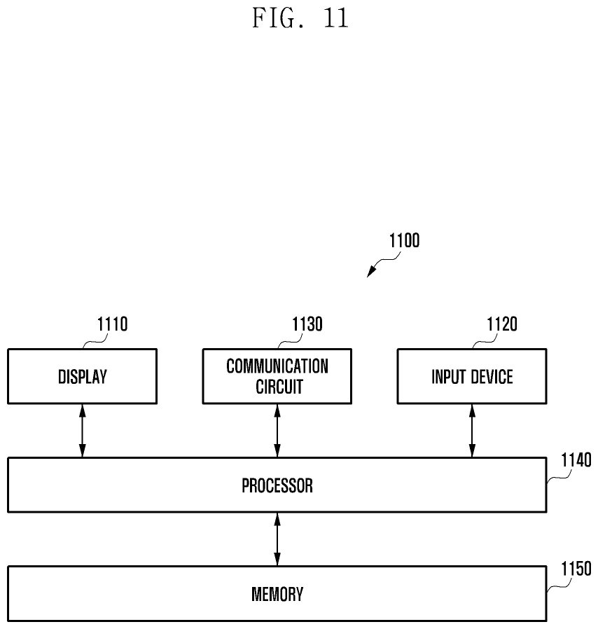

FIG. 11 is a block diagram illustrating a recipient electronic device according to an embodiment.

As described above, the same electronic device may be operated as a sender electronic device (or a first electronic device) (e.g., the first electronic device 210 of FIG. 2) or a recipient electronic device (or a second electronic device) (e.g., the second electronic device 220 of FIG. 2) depending on a situation where message data is transmitted or received. In FIG. 11, an embodiment in which an electronic device 1100 may be operated as the recipient electronic device will be described.

As illustrated in FIG. 11, the electronic device 1100 according to an embodiment may include a display 1110, an input device 1120, a communication circuit 1130, a processor 1140, and a memory 1150. At least some of the configurations and/or functions may be the same as the electronic device 300 of FIG. 3 (e.g., the display 310, the input device 320, the communication circuit 330, the processor 340, and the memory 350), and the same characteristics will be herein omitted.

According to an embodiment, the communication circuit 1130 may receive message data from an external device (e.g., the first electronic device 210 of FIG. 2).

According to an embodiment, the processor 1140 may analyze at least one of text and an image included in the received message data. The processor 1140 may identify whether the received message data is sensitive data on the basis of the analysis result.

According to an embodiment, the processor 1140 may analyze the text included in the message data through natural language understanding to identify whether the message data is the sensitive data. For example, the processor 1140 may analyze key phrase, semantic and syntactic features, characteristic of language, third person references to receiver, considered topics, personal information, and the like of the input text.

According to an embodiment, the processor 1140 may analyze the image included in the message data through object recognition to identify whether the message data is the sensitive data. For example, the processor 1140 may analyze whether the image includes erotic scenes, brutal scenes, private scenes, family photos, etc., through various image analysis methods.

According to an embodiment, the electronic device 1100 may identify whether the message data is the sensitive data on the basis of information received from an external device (e.g., the message processing server 230 of FIG. 2).

According to an embodiment, the processor 1140 may determine a display method of the message data through a display 1110 on the basis of the identification result concerning whether the message data is the sensitive data. For example, if the received message data is the sensitive data, the processor 1140 may be configured to display a Graphic User Interface (GUI) for allowing the user to decide whether the message data is to be displayed, and to display the sensitive data on the display 1110 on the basis of a user input for the GUI.

According to an embodiment, if the message data is the sensitive data, the processor 1140 may be configured to determine the display method of the message data on the basis of at least one of current time, date, and place.

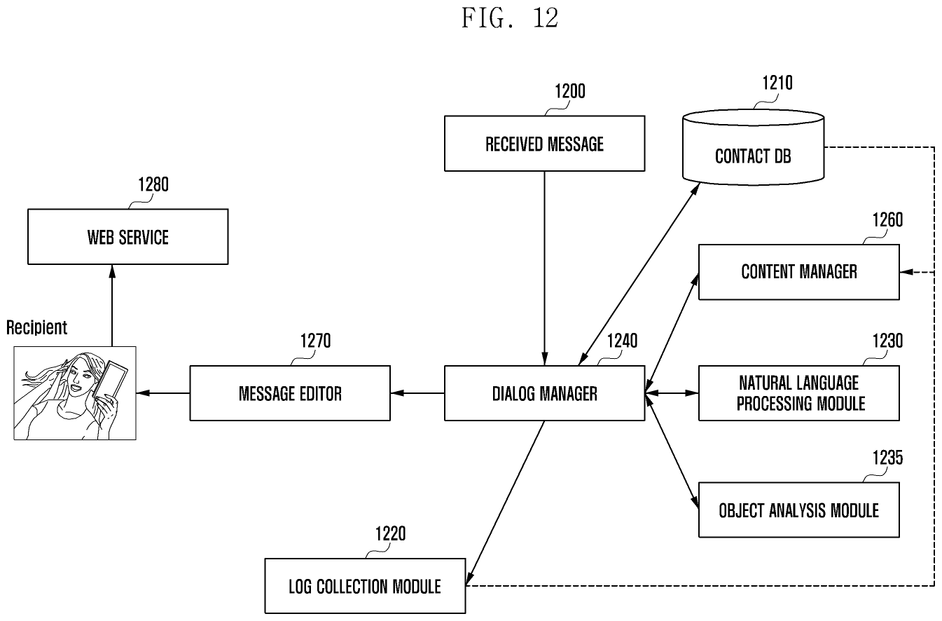

FIG. 12 illustrates modules of a recipient electronic device and/or message processing server according to an embodiment.

An electronic device may receive message data 1200 from another electronic device (e.g., the first electronic device 210 of FIG. 2). The received message data may be provided to a dialog manager 1240.

The dialog manager 1240 may include a content manager 1260, a natural language processing module 1230, an object analysis module 1235, and a log collection module 1220.

The message transmission and/or reception records of the electronic device may be stored by the log collection module 1220, and information collected by the log collection module 1220 may be provided to the dialog manager 1240.

The natural language processing module 1230 may analyze text included in the message data through natural language understanding to identify whether the message data is sensitive data.

The object analysis module 1235 may analyze an image included in the message data through object recognition to identify whether the message data is the sensitive data.

The content manager 1260 may determine the display method of the message data including the sensitive data according to configured rules. For example, the content manager 1260 may not display the message data or may change the sensitive data to a web link capable of identifying the sensitive data.

According to an embodiment, the dialog manger 1240 may identify whether the message data is the sensitive data according to a category to which a sender belongs.

If the message data includes the sensitive data, the dialog manger 1240 may display a GUI for deciding whether the message data is to be displayed, and may display the sensitive data on the display on the basis of a user input through the GUI. Alternatively, if the sensitive data is changed to the web link by the content manager 1260, the user may access a corresponding web service 1280 to identify the sensitive data by activating the web link.

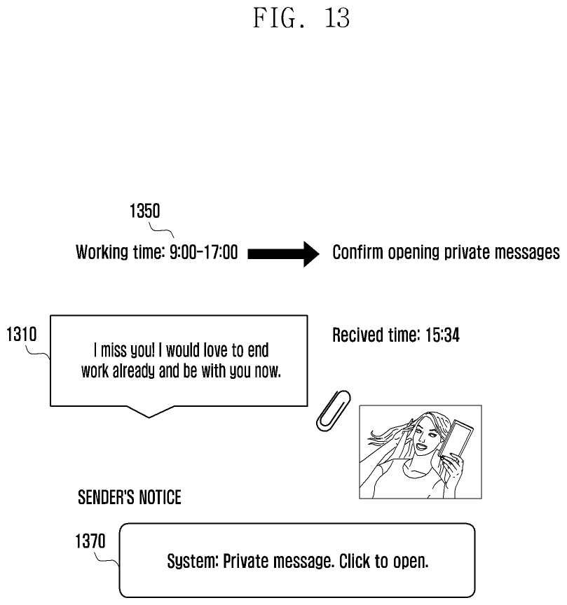

FIG. 13 illustrates a method in which a recipient electronic device processes message data according to an embodiment.

According to an embodiment, if the received message data is sensitive data, an electronic device (e.g., the electronic device 1100 of FIG. 11) may determine a display method of message data (e.g., whether to display the message data) on the basis of predetermined settings including at least one of the current time, date, and place. According to an embodiment, a user may configure at least one of the time, date, and place where the sensitive data can be displayed.

Referring to FIG. 13, the user may configure whether to display a private message received at a specific time 1350 (e.g., business hours 09:00 to 17:00). For example, if a message 1310 “I miss you! I would love to end work already and be with you now.” is received at 15:34 belonging to the configured time, which the electronic device identifies as sensitive data, an alarm 1370 capable of determining whether to display the message without directly displaying the message data may be displayed.

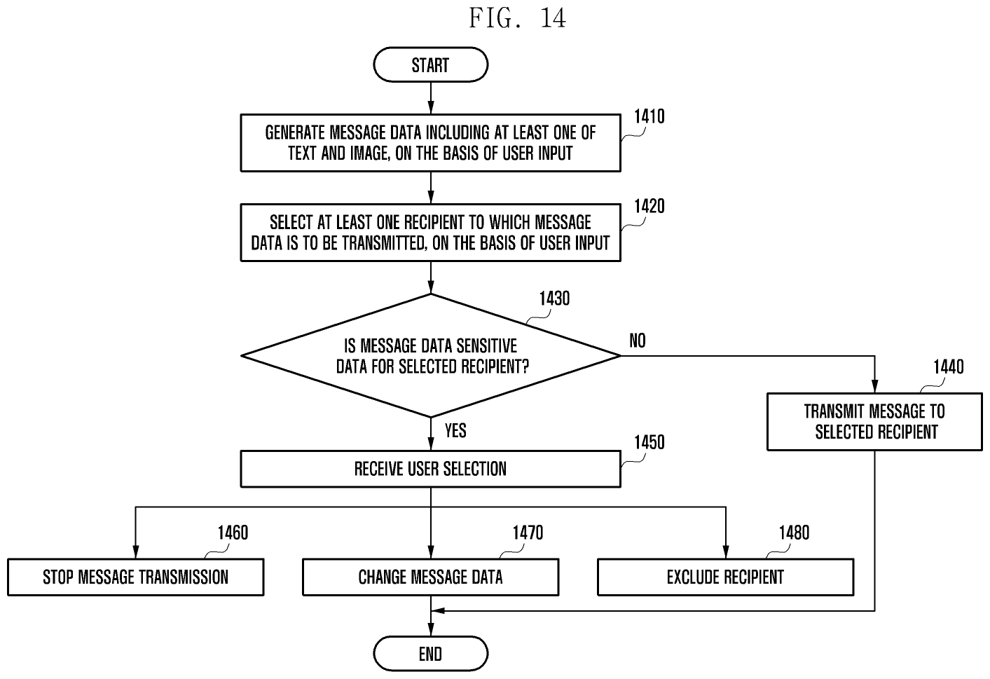

FIG. 14 is a flowchart illustrating a method of processing message data of a sender electronic device according to an embodiment.

The illustrated method may be performed by the electronic device 300 of FIG. 3, and the description of the technical features described above will be omitted below.

In operation 1410, the electronic device may generate message data including at least one of text and an image on the basis of a user input. The electronic device may generate the message data on the basis of a user input through a touch screen or a voice input device.

In operation 1420, the electronic device may select at least one recipient to which the message data is to be transmitted on the basis of a user input. Recipient information may be input as a phone number, an ID, an e-mail account, or the like, and may be selected by the user from a contact list stored in a first electronic device or may be input directly by the user (e.g., phone number can be directly input by a user). The user may select a plurality of recipients to which the same message data is to be transmitted. The recipients may be determined in advance by the user input, and/or the user may select a group including a plurality of recipients categorized according to the analysis of a processor or an external device (e.g., the message processing server), as the recipients.

In operation 1430, the electronic device may identify whether the input message data is sensitive data for the selected recipient. The sensitive data may refer to textual and/or image data that contains information related to security and/or privacy as information whose content is inappropriate to reveal to selected recipients.

According to an embodiment, the processor may analyze text included in the message data through natural language understanding to identify whether the message data is the sensitive data. In addition, the processor may analyze an image included in the message data through object recognition to identify whether the message data is the sensitive data.

According to an embodiment, the message data may be determined to be the sensitive data only for a specific recipient (or a specific category).

If the message data is not the sensitive data on the basis of the identification result of operation 1430, in operation 1440, the electronic device may transmit the created message data to the selected recipient.

If the message data includes the sensitive data on the basis of the identification result of operation 1430, in operation 1450, the electronic device may provide a menu capable of determining a transmission method of the message data to the user, and receive the selection of the user.

According to the selection in operation 1450, the electronic device may stop the transmission of the message data in operation 1460, change a portion of the sensitive data included in the message data in operation 1470, or change at least some of the selected recipients (e.g., exclude a person from the recipients) in operation 1480.

It will be evident to those skilled in the art that various modifications and changes may be made in the embodiments of the present disclosure without departing from the technical idea or the gist of the inventive concept. Therefore, it should be understood that the above-mentioned embodiments are not limiting but illustrative in all aspects. It should be understood that the drawings and the detailed description are not intended to limit the inventive concept to the particular forms disclosed herein, but on the contrary, the intention is to cover all modifications, equivalents, and alternatives falling within the spirit and scope of the inventive concept as defined by the appended claims.

What is claimed is:

1. An electronic device comprising:
an input device configured to receive a user input;
a communication circuit; and
a processor configured to:
generate message data including at least one of text or an image based on the user input,
select at least one recipient of the message data based on the user input,
identify whether the message data is sensitive data for the at least one recipient, and
based on the sensitive data being identified as the sensitive data for the at least one recipient, determine a transmission method of the message data.

2. The electronic device of claim 1, wherein, if the message data is the sensitive data for the selected recipient, the processor is configured to stop the transmission of the message data or to change the at least of the text or the image included in the message data.

3. The electronic device of claim 1, wherein, if the message data is the sensitive data for the selected recipient, the processor is configured to change the at least one recipient.

4. The electronic device of claim 1, wherein the processor is configured to identify whether the message data is the sensitive data based on information received from an external device.

5. The electronic device of claim 1, wherein the processor is configured to analyze the text included in the message data through natural language processing to identify whether the message data is the sensitive data.

6. The electronic device of claim 1, wherein the processor is configured to analyze the image included in the message data through object recognition to identify whether the message data is the sensitive data.

7. The electronic device of claim 1, wherein the processor is configured to determine a category to which the at least one recipient belongs based on preset category information, and identify whether the message data is the sensitive data based on the category of the at least one recipient.

8. The electronic device of claim 1, wherein the processor is configured to determine a category to which the at least one recipient belongs based on at least one of predetermined rules, message transmission statistics, or message content analysis.

9. An electronic device comprising:
a communication circuit configured to receive message data from an external device;
a display; and
a processor configured to:
analyze at least one of text or an image included in the message data,
identify whether the message data is sensitive data based on an analysis result, and
determine a display method of the message data through the display based on the identification result.

10. The electronic device of claim 9, wherein the processor is configured to identify whether the message data is the sensitive data based on information received from the external device.

11. The electronic device of claim 9, wherein the processor is configured to, if the message data is the sensitive data, display a Graphic User Interface (GUI) for deciding whether to display the message data.

12. The electronic device of claim 9, wherein, if the message data is the sensitive data, the processor is configured to determine the display method of the message based on the predetermined settings include at least one of a time, a date, or a place.

13. A message processing method of an electronic device, the message processing method comprising:
generating message data including at least one of text or an image based on a user input;
selecting at least one recipient of the message data;
identifying whether the message data is sensitive data for the at least one recipient; and
based on the sensitive data being identified as the sensitive data for the at least one recipient, determining a transmission method of the message data.

14. The message processing method of claim 13, wherein if the message data is the sensitive data for the selected recipient, the determining of the transmission method comprises at least one of:
stopping the transmission of the message data; and
changing the at least of the text or the image included in the message data.

15. The message processing method of claim 13, wherein, if the message data is the sensitive data for the selected recipient, the determining of the transmission method of the message data comprises: excluding the at least one recipient.

16. The message processing method of claim 13, wherein the identifying of whether the message data is the sensitive data comprises identifying whether the message data is the sensitive data based on information received from an external device.

17. The message processing method of claim 13, wherein the identifying of whether the message data is the sensitive data comprises analyzing the text included in the message data through natural language understanding to identify whether the message data is the sensitive data.

18. The message processing method of claim 13, wherein the identifying of whether the message data is the sensitive data comprises analyzing the image included in the message data through object recognition to identify whether the message data is the sensitive data.

19. The message processing method of claim 13, wherein the identifying of whether the message data is the sensitive data comprises determining a category to which the at least one recipient belongs based on preset category information, and identifying whether the message data is the sensitive data based on the category of the at least one recipient.

20. The message processing method of claim 19, wherein the determining of the category to which the at least one recipient belongs includes determining the category to which the at least one recipient belongs based on at least one of predetermined rules, message transmission statistics, or message content analysis.
